(19) United States
(12) Patent Application Publication
(10) Pub. No.: US 2014/0199069 A1
(43) Pub. Date: Jul. 17, 2014

(54) IDLE INSERTION FOR PHYSICAL LAYER RATE ADAPTION AND TIME-DIVISION DUPLEXING

(71) Applicant: Qualcomm Incorporated, San Diego, CA (US)

(72) Inventors: Andrea Garavaglia, Nuremberg (DE); Patrick Stupar, Nuremberg (DE)

(73) Assignee: Qualcomm Incorporated, San Diego, CA (US)

(21) Appl. No.: 13/950,046

(22) Filed: Jul. 24, 2013

Related U.S. Application Data
(60) Provisional application No. 61/752,748, filed on Jan. 15, 2013.

(51) Int. Cl. H04Q 11/00

(52) U.S. Cl. CPC H04Q 11/0067
USPC 398/66

(57) ABSTRACT

A method is performed in a communication device that includes one or more media access control (MAC) entities, a coax physical layer (PHY), and a media-independent interface coupling the one or more MAC entities with the coax PHY. In the method, a bitstream is generated that includes data frames and characters corresponding to time windows in which the coax PHY does not transmit signals. The bitstream is provided to the coax PHY through the media-independent interface. Signals corresponding to the data frames are transmitted from the coax PHY during a transmit mode. The coax PHY enters a receive mode when the bitstream contains the characters corresponding to the time windows.

### RELATED APPLICATION

This application claims priority to U.S. Provisional Patent Application No. 61/752,748, titled “Idle Insertion for Physical Layer Rate Adaptation and Control,” filed Jan. 15, 2013, which is hereby incorporated by reference in its entirety.

### TECHNICAL FIELD

The present embodiments relate generally to communication systems, and specifically to Ethernet communication systems.

### BACKGROUND OF RELATED ART

The Ethernet Passive Optical Networks (EPON) protocol may be extended over coaxial (coax) links in a cable plant. The EPON protocol as implemented over coax links is called EPON Protocol over Coax (EPoC). Implementing an EPoC network or similar network over a coax cable plant presents significant challenges. For example, communications over the cable plant may use time-division duplexing (TDD). Furthermore, a coax physical layer (PHY) may have a lower data rate than the media-independent interface that couples the PHY to a media access control (MAC) entity.

### BRIEF DESCRIPTION OF THE DRAWINGS

The present embodiments are illustrated by way of example and are not intended to be limited by the figures of the accompanying drawings.

FIG. 1A is a block diagram of a coaxial network in accordance with some embodiments.

FIG. 1B is a block diagram of a network that includes both optical links and coax links in accordance with some embodiments.

FIG. 2A is a block diagram showing data communications protocol stacks in a coax line terminal and a coax network unit in accordance with some embodiments.

FIG. 2B shows an example of a transmit or receive bitstream conveyed by a media-independent interface in accordance with some embodiments.

FIG. 2C illustrates timing of upstream and downstream time windows as measured at a coax line terminal in accordance with some embodiments.

FIGS. 3A and 3B are flowcharts with pseudo-code illustrating functionality of state machines that perform de-rating idle character insertion for downstream transmission, in accordance with some embodiments.

FIG. 4A is a flowchart with pseudo-code illustrating functionality of a state machine that performs FEC idle character deletion for downstream transmission, in accordance with the EPON standard.

FIG. 4B is a flowchart with pseudo-code illustrating functionality of a state machine that performs de-rating idle character deletion for downstream transmission, in accordance with some embodiments.

FIG. 4C is a flowchart with pseudo-code illustrating functionality of a state machine that combines the functionality of the state machines of FIGS. 4A and 4B for downstream transmission in accordance with some embodiments.

FIG. 5 is a flowchart with pseudo-code illustrating functionality of a state machine for downstream reception idle insertion in accordance with some embodiments.

FIGS. 6A and 6B are flowcharts with pseudo-code illustrating functionality of state machines for performing de-rating idle insertion for upstream transmission in accordance with some embodiments.

FIG. 7 is a flowchart with pseudo-code illustrating functionality of a state machine that deletes idle characters for upstream transmissions in accordance with some embodiments.

FIG. 8 is a flowchart with pseudo-code illustrating functionality of a state machine for upstream reception idle insertion in accordance with some embodiments.

FIG. 9 is a flowchart showing a communications method in accordance with some embodiments.

FIG. 10A is a block diagram of a fiber-coax unit in accordance with some embodiments.

FIG. 10B is a block diagram of a coax network unit in accordance with some embodiments.

Like reference numerals refer to corresponding parts throughout the drawings and specification.

### DETAILED DESCRIPTION

Embodiments are disclosed in which characters are inserted into a bitstream to accommodate time-division duplexing and/or rate adaption.

In some embodiments, a method is performed in a communication device that includes one or more media access control (MAC) entities, a coax physical layer (PHY), and a media-independent interface coupling the one or more MAC entities with the coax PHY. A bitstream is generated that includes data frames and characters corresponding to time windows in which the coax PHY does not transmit signals. The bitstream is provided to the coax PHY through the media-independent interface. Signals corresponding to the data frames are transmitted from the coax PHY during a transmit mode. The coax PHY enters a receive mode when the bitstream contains the characters corresponding to the time windows.

In some embodiments, a communication device includes one or more MAC entities to provide data frames and a coax PHY to transmit signals corresponding to the data frames during a transmit mode and to cease transmission during a receive mode. The communication device also includes a media-independent interface to provide to the coax PHY a bitstream that includes the data frames and characters corresponding to time windows in which the coax PHY does not transmit signals. The coax PHY is to enter the receive mode when the bitstream contains the characters corresponding to the time windows.

In some embodiments, a non-transitory computer-readable storage medium stores one or more programs configured to be executed by one or more processors in a communication device. The one or more programs include instructions to generate a bitstream that includes data frames and characters corresponding to time windows in which a coax PHY in the communication device does not transmit signals. The one or more programs also include instructions to provide the bitstream to the coax PHY through a media-independent interface in the communication device. The coax PHY is to transmit signals corresponding to the data frames during a transmit mode and to enter a receive mode when the bitstream contains the characters corresponding to the time windows.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

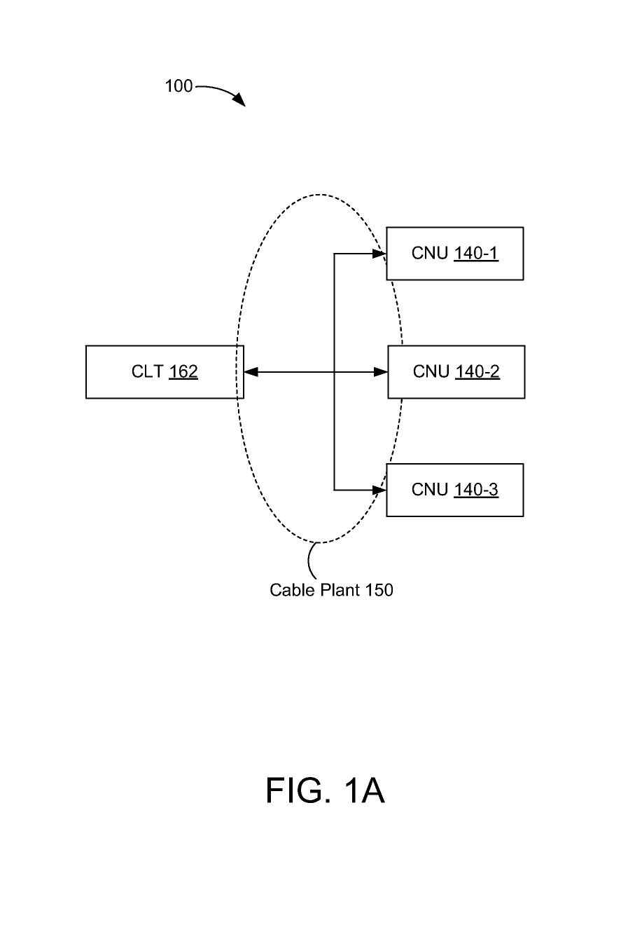

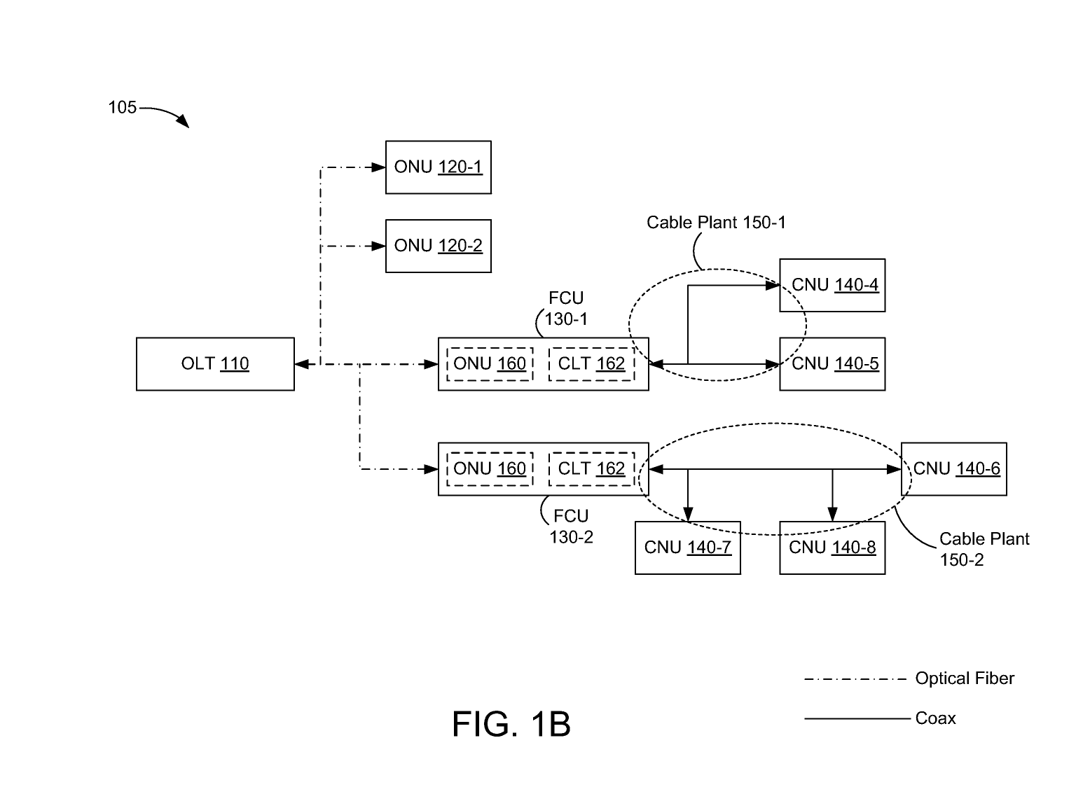

FIG. 1A is a block diagram of a coax network 100 (e.g., an EPoC network) in accordance with some embodiments. The network 100 includes a coax line terminal (CLT) 162 coupled to a plurality of coax network units (CNUs) 140-1, 140-2, and 140-3 via coax links. A respective coax link may be a passive coax cable, or may also include one or more amplifiers and/or equalizers. The coax links compose a cable plant 150. In some embodiments, the CLT 162 is located at the headend of the cable plant 150 or within the cable plant 150 and the CNUs 140 are located at the premises of respective users.

The CLT 162 transmits downstream signals to the CNUs 140-1, 140-2, and 140-3 and receives upstream signals from the CNUs 140-1, 140-2, and 140-3. In some embodiments, each CNU 140 receives every packet transmitted by the CLT 162 and discards packets that are not addressed to it. The CNUs 140-1, 140-2, and 140-3 transmit upstream signals at scheduled times (e.g., in scheduled time slots) specified by the CLT 162. For example, the CLT 162 transmits control messages (e.g., GATE messages) to the CNUs 140-1, 140-2, and 140-3 specifying respective future times at which respective CNUs 140 may transmit upstream signals.

In some embodiments, the CLT 162 is part of a fiber-coax unit (FCU) 130 that is also coupled to an optical line terminal (OLT) 110, as shown in FIG. 1B. FIG. 1B is a block diagram of a network 105 that includes both optical links and coax links in accordance with some embodiments. The network 105 includes an optical line terminal (OLT) 110 coupled to a plurality of optical network units (ONUs) 120-1 and 120-2 via respective optical fiber links. The OLT 110 also is coupled to a plurality of fiber-coax units (FCUs) 130-1 and 130-2 via respective optical fiber links. (FCUs are sometimes also referred to as optical-coax units or OCUs).

In some embodiments, each FCU 130-1 and 130-2 includes an ONU 160 coupled with a CLT 162. The ONU 160 receives downstream packet transmissions from the OLT 110 and provides them to the CLT 162, which forwards the packets to the CNUs 140 on its cable plant 150. In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1B, the first FCU 130-1 communicates with CNUs 140-4 and 140-5, and the second FCU 130-2 communicates with CNUs 140-6, 140-7, and 140-8. The coax links coupling the first FCU 130-1 with CNUs 140-4 and 140-5 compose a first cable plant 150-1. The coax links coupling the second FCU 130-2 with CNUs 140-6 through 140-8 compose a second cable plant 150-2. A respective coax link may be a passive coax cable, or alternately may include one or more amplifiers and/or equalizers. In some embodiments, the OLT 110, ONUs 120-1 and 120-2, and optical portions of the FCUs 130-1 and 130-2 are implemented in accordance with the Ethernet Passive Optical Network (EPON) protocol.

In some embodiments, the OLT 110 is located at a network operator's headend, the ONUs 120 and CNUs 140 are located at the premises of respective users, and the FCUs 130 are located at the headends of their respective cable plants 150 or within their respective cable plants 150.

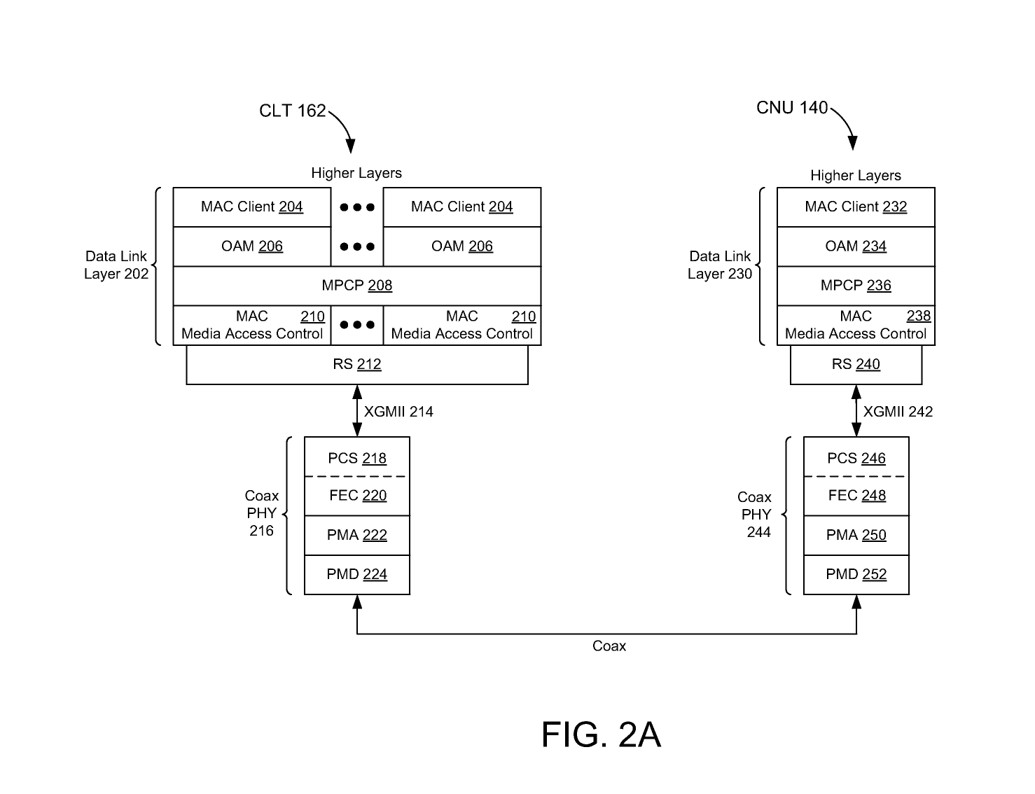

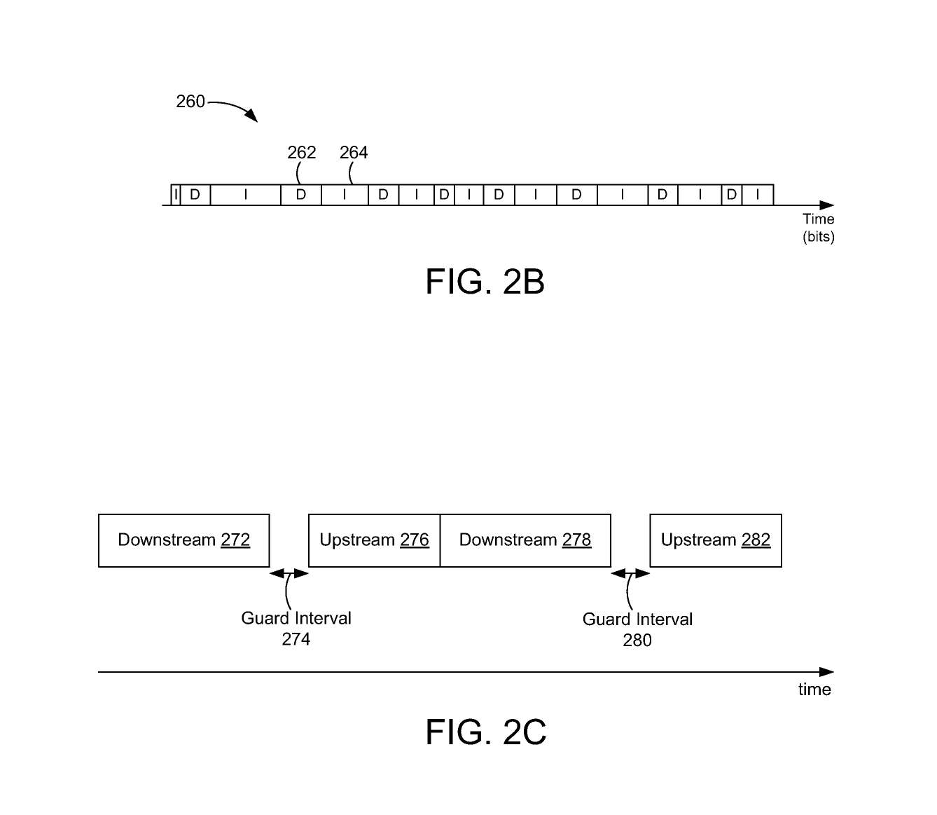

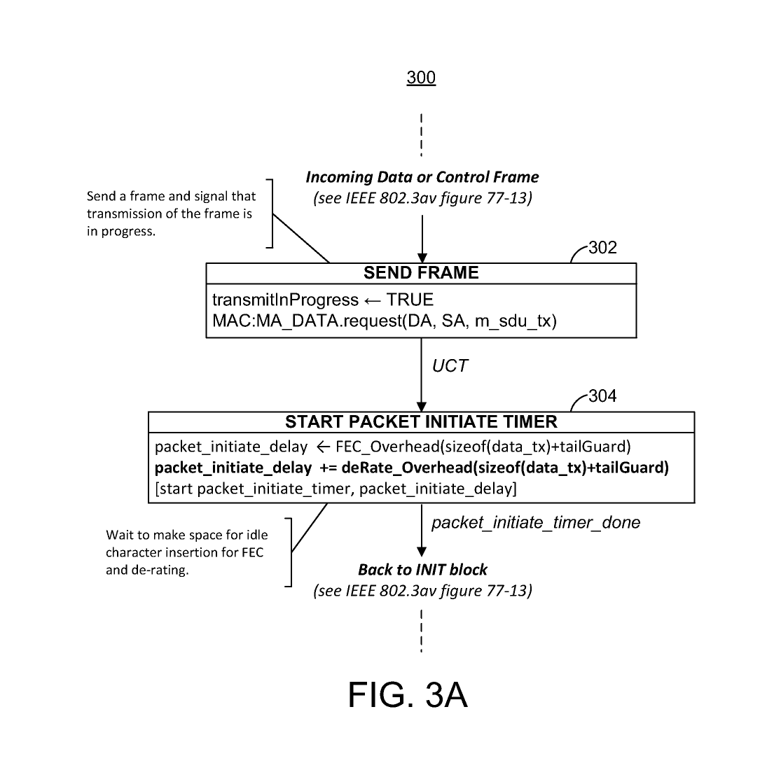

FIG. 2A is a block diagram showing data communications protocol stacks in a CLT 162 and a CNU 140 coupled to the CLT 162 (e.g., as shown in FIG. 1A or 1B) in accordance with some embodiments. The CLT 162 includes an instantiation (i.e., an implementation) of a data link layer 202 that is coupled to an instantiation (i.e., an implementation) of a coax physical layer (PHY) 216 through a reconciliation sublayer (RS) 212 and a 10 Gigabit Media-Independent Interface (XGMII) 214 (or other media-independent interface). The instantiation of the data link layer 202 includes a plurality of media access control (MAC) clients 204. In some embodiments, each MAC client 204 corresponds to a distinct logical link identifier (LLID). The MAC clients 204 may be coupled to respective operations, administration, and management (OAM) sublayers 206, which optionally may be omitted. A multi-point MAC control sublayer 208 implements a multi-point control protocol (MPCP) and thus may be referred to as an MPCP sublayer 208. The multi-point control protocol is applied to a plurality of full-duplex MAC entities 210 (also referred to as MAC controls). In some embodiments, each MAC entity 210 corresponds to a distinct LLID. The coax PHY 216 includes a physical coding sublayer (PCS) 218, a forward-error-correction (FEC) codec 220 (which may be implemented in the PCS 218), a physical medium attachment sublayer (PMA) 222, and a physical medium dependent sublayer (PMD) 224.

For transmission, the RS 212 provides a transmit bitstream to the PCS 218 through the XGMII 214. For reception, the PCS 218 provides a receive bitstream to the RS 212 through the XGMII 214. In some embodiments, the transmit and receive bitstreams are continuous bitstreams with fixed data rates (e.g., 10 Gbps). The rate of the XGMII 214 is higher than the rate of the coax PHY 216.

The CNU 140 includes an instantiation (i.e., an implementation) of a data link layer 230 that is coupled to an instantiation (i.e., an implementation) of a coax PHY 244 through an RS 240 and an XGMII (or other media-independent interface) 242. The instantiation of the data link layer 230 includes a MAC client 232, an OAM sublayer 234, an MPCP sublayer 236, and a full-duplex MAC entity 238 (also referred to as a MAC control). The coax PHY 244 includes a PCS 246, an FEC codec 248 (which may be implemented in the PCS 246), a PMA 250, and a PMD 252. For transmission, the RS 240 provides a transmit bitstream to the PCS 246 through the XGMII 242. For reception, the PCS 246 provides a receive bitstream to the RS 240 through the XGMII 242. In some embodiments, the transmit and receive bitstreams are continuous bitstreams with fixed data rates (e.g., 10 Gbps). The rate of the XGMII 242 is higher than the rate of the coax PHY 244.

Transmit and receive bitstreams conveyed by the XGMIIs 214 and/or 242 (or other media-independent interfaces) may be divided into groups of bits referred to as vectors.

FIG. 2B shows an example of a transmit or receive bitstream 260 conveyed by an XGMII 214 or 242 (or other media-independent interface) in accordance with some embodiments. The bitstream 260 includes data frames 262 and idle characters 264. The data frames 262 and/or idle characters 264 may include multiple data and/or idle vectors, respectively. In the CLT 162, the idle characters 264 in the transmit bitstream may be added by MAC entities 210 and/or the RS 212. In the CNU 140, the idle characters 264 in the transmit bitstream may be added by the MAC entity 238 and/or the RS 240.

Idle characters 264 in the bitstream 260 may serve various purposes. For example, the transmit bitstreams may include idle characters that provide space for inter-packets gaps. These idle characters are encoded in the PCS 218 and/or PCS 246 and transmitted as separation between frames. The transmit bitstreams may include idle characters that provide space for FEC parity bits. The PCS 218 and/or PCS 246 replace these idle characters with the parity bits as generated by the FEC codecs 220 and/or 248 (e.g., using a Reed-Solomon code such as an RS(255,223) code). The transmit bitstreams may include idle characters that indicate an absence of traffic. These idle characters are encoded in the PCS 218 and/or PCS 246 and are used to maintain synchronization.

The transmit bitstreams may also include idle characters that are used to implement time-division duplexing (TDD). In time-division duplexing, the same frequency band (or set of bands) is used for both downstream transmission from the CLT 162 to CNUs 140 and upstream transmission from CNUs 140 to the CLT 162. Downstream time windows are defined for transmissions from the CLT 162 to CNUs 140. Upstream time windows are defined for transmissions from CNUs 140 to the CLT 162; a CNU 140 may transmit during an upstream time window if it has been assigned a time slot during the upstream time window (e.g., by a GATE message).

In the CLT 162, the transmit bitstream may include idle characters that correspond to the upstream time windows. The PCS 218 (and thus the coax PHY 216) switches to receive mode while receiving these idle characters, and thus is prevented from transmitting during upstream time windows. These idle characters therefore are not transmitted. In some embodiments, a control signal is transmitted across the XGMII interface 214 along with these idle characters; the control signal instructs the PCS 218 to enter receive mode. In some other embodiments, a dedicated idle character is used for these idle characters; the PCS 218 enters receive mode in response to the dedicated idle characters.

In a CNU 140, the transmit bitstream may include idle characters that correspond to the downstream time windows. The PCS 246 (and thus the coax PHY 244) switches to receive mode while receiving these idle characters, and thus is prevented from transmitting during downstream time windows. These idle characters therefore are not transmitted. In some embodiments, a control signal is transmitted across the XGMII interface 242 along with these idle characters; the control signal instructs the PCS 246 to enter receive mode. In some other embodiments, a dedicated idle character is used for these idle characters; the PCS 246 enters receive mode in response to the dedicated idle characters.

FIG. 2C illustrates timing of upstream and downstream time windows as measured at a CLT 162 in accordance with some embodiments. As shown in FIG. 2C, alternating time windows are allocated for upstream and downstream transmissions. During a downstream time window 272, the CLT 162 transmits signals downstream to CNUs 140. The downstream window 272 is followed by a guard interval 274, after which the CLT 162 receives upstream signals from one or more of the CNUs 140 during an upstream time window 276. The guard interval 274 accounts for propagation time on the coaxial links and for switching time in the CLT 162 to switch from transmit mode to receive mode. The guard interval 274 thus ensures separate upstream and downstream time windows at the CNUs 140. The upstream time window 276 is immediately followed by another downstream time window 278, another guard interval 280, and another upstream time window 282. Alternating downstream and upstream time windows continue in this manner, with successive downstream and upstream time windows being separated by guard intervals and the downstream time windows immediately following the upstream time windows, as shown in FIG. 2C. The upstream and downstream transmissions during the time windows 272, 276, 278, and 282 use the same frequency band. The time allocated for upstream time windows (e.g., time windows 276 and 282) may be different than the time allocated for downstream time windows (e.g., time windows 272 and 278). FIG. 2C illustrates an example in which more time (and thus more bandwidth) is allocated to downstream time windows 272 and 278 than to upstream time windows 276 and 282.

The transmit bitstreams may further include idle characters that are used for de-rating to match the rates of the coax PHYs 216 and/or 244 to the rates of the respective XGMII interfaces 214 and/or 242. The PCS 218 and/or PCS 246 remove these idle characters before encoding. These idle characters prevent overloading of the coax PHYs 216 and/or 244 as a result of the higher rates of the XGMII interfaces 214 and 242 as compared to the coax PHYs 216 and 244.

In some embodiments, state machines used for EPON (e.g., as defined in the IEEE 802.3av EPON standard (“the EPON standard”)) may be modified to insert idle characters into the transmit bitstreams for de-rating. The same FEC function as used in EPON may be used with adjusted parameters:

FEC_{—}DSize+FEC_{—}PSize=CW_Size (1)

FEC_{—}DSize/(FEC_{—}DSize+FEC_{—}PSize)=coding_rate≦1 (2)

where FEC_DSize is the number of data payload bits (not including parity bits) in an FEC code word, FEC_PSize is the number of parity bits in an FEC code word, and CW_Size is the total number of bits in an FEC code word.

Idle characters for de-rating are added in proportion to the effective rate R_{c} of the coax PHY 216 or 244 with respect to the data rate Rₓ of the XGMII 214 or 242. R_{c} is the effective coax PHY rate after discounting all overhead (e.g., including cyclic prefix, pilot symbols, guard intervals, preambles, etc.). A ratio R between idle bytes and data bytes (where the data bytes include payload and parity bytes) is then determined:

$$R = ( \frac{{R}_{x}}{{R}_{c}} - 1 ) \geq 0 \qquad ( 3 )$$

The number of data bytes D (including payload and parity bytes) in a packet is multiplied by R to determine the number of idle bytes to be added to the transmit bitstream for de-rating. For example, if R_{c}=2 Gbps and Rₓ=10 Gbps, R=4 and four idle bytes are added for each data byte.

A function deRate_Overhead(length) is defined that specifies the additional number of bytes of idles to be added for de-rating:

deRate_Overhead(length)=ceiling(length*R/coding_rate) (4)

where length is the payload data length (i.e., including information bits only and not parity bits) and the ceiling function rounds up to the next integer. In some embodiments, the de-rating idle characters are added by increasing a packet initiation delay (the “packet initiate delay” or “initiate delay”) in the MAC entities 210 or 238 or in the RS 212 or 240.

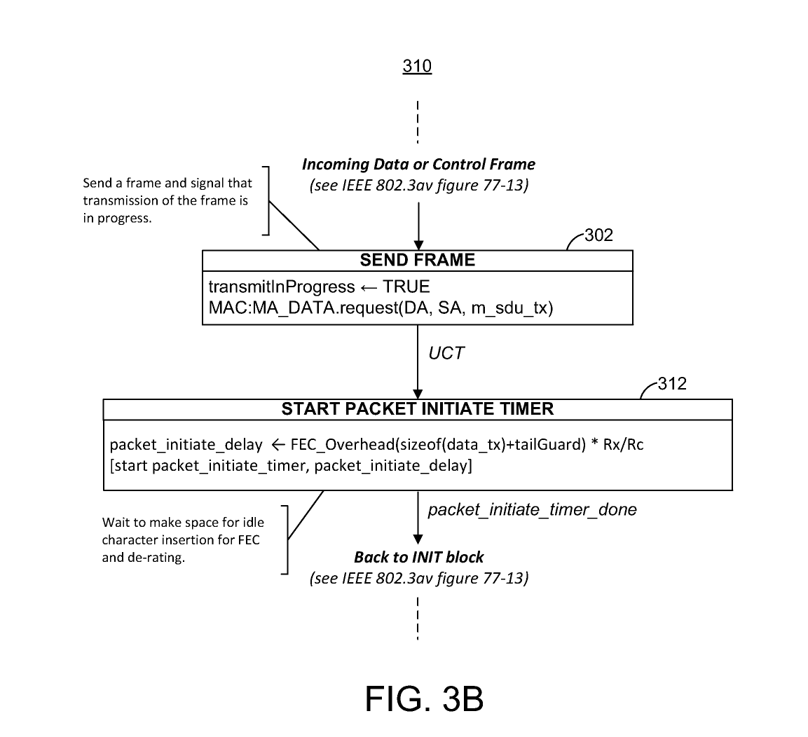

The following figures, FIGS. 3A-8, are flowcharts with pseudo-code for performing idle character insertion or deletion. In these flowcharts, text next to arrows state conditions to be satisfied for a transition from a previous state or operation to a subsequent state or operation to occur. The term “UCT” refers to an unconditional transition, in which the transition occurs without any condition being satisfied. Unless otherwise defined herein, variables and functions in these figures are used in accordance with the EPON standard.

FIG. 3A is a flowchart with pseudo-code 300 illustrating functionality of a state machine that performs idle character insertion using equation (4) for downstream transmission, in accordance with some embodiments. The state machine of FIG. 3A may be implemented, for example, in a MAC entity 210 or RS 212 in the CLT 162 (FIG. 2A). A “send frame” state 302 is entered in response to an incoming data or control frame. In the “send frame” state 302, the data or control frame is sent across a media-independent interface (e.g., XGMII 214, FIG. 2A) to a PHY (e.g., coax PHY 216, FIG. 2A), and transmission of the data or control frame across the media-independent interface is signaled.

An unconditional transition is made from the “send frame” state 302 to a “start packet initiate timer” state 304. In the “start packet initiate timer” state 304, a packet initiation delay (“packet_initiate_delay”) is set equal to the FEC overhead calculated based on the payload (“sizeof(data_tx)”) of the transmit protocol data unit (PDU) and the PDU overhead (as specified by tailGuard, which accounts for the preamble, frame header, and inter-packet gap). The packet initiation delay is increased by an amount determined using the deRate_Overhead function of equation (4), to account for de-rating. A timer (“packet_initiate_timer”) is run for a period of time corresponding to the packet initiation delay; during this period, idle characters are inserted into the transmit bitstream. The function deRate_Overhead thus specifies the amount of time that a multiplexer in the MPCP sublayer 208 waits following transmission of a frame of size length to accommodate de-rating. The function FEC_Overhead specifies the amount of time that the multiplexer waits following transmission of a frame of size length to accommodate parity bit insertion, inter-packet gaps, and other overhead. The variable m_sdu_tx specifies the transmit packet length. Upon returning to the INIT block, the variable transmitlnProgress is reset to false, to return control to the transmit controller in the MPCP sublayer 208 and allow transmission of the next packet.

Alternatively, the packet initiation delay is scaled by a scaling factor of Rₓ/R_{c} that accounts for the rate differences between a media-independent interface and corresponding PHY (e.g., between the XGMII interface 214 and coax PHY 216). FIG. 3B illustrates pseudo-code 310 for a state machine that uses this scaling factor, as an alternative to the pseudo-code 300 of FIG. 3A. The “start packet initiate timer” state 304 of FIG. 3A is replaced with a “start packet initiate timer” state 312, in which the packet initiation delay (“packet_initiate_delay”) is set equal to the FEC overhead determined based on the payload size (“sizeof(data_tx)”) and PDU overhead (“tailGuard”), multiplied by the scaling factor Rₓ/R_{c}.

In systems implemented in accordance with the examples of FIGS. 3A and 3B, the variable fecOffset (e.g., as defined in the EPON standard) counts at the rate R_{c} instead of Rₓ.

The idle characters added to the transmit bitstream for de-rating are deleted in the PCS 218 or 246 (FIG. 2A). The number of idle characters to be deleted to remove all idle characters that were added for de-rating is determined based on R, as defined in equation (3): for every D data bytes (including payload and parity bytes), R*D idle bytes are deleted. A parameter is defined:

deRate_Size=R/coding_rate (5)

that specifies the number of idle vectors to be deleted for each data vector transmitted over the XGMII interface 214 or 242 (or other media-independent interface). In addition, idles added to create room for FEC parity bits are removed and replaced with the FEC parity bits.

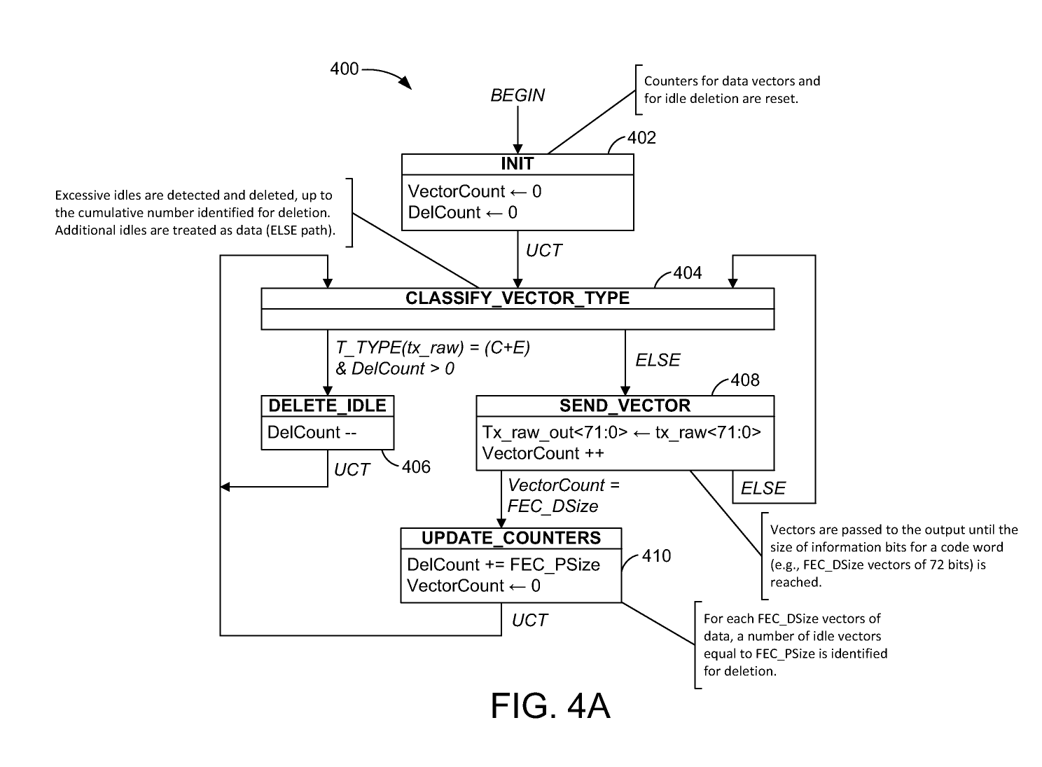

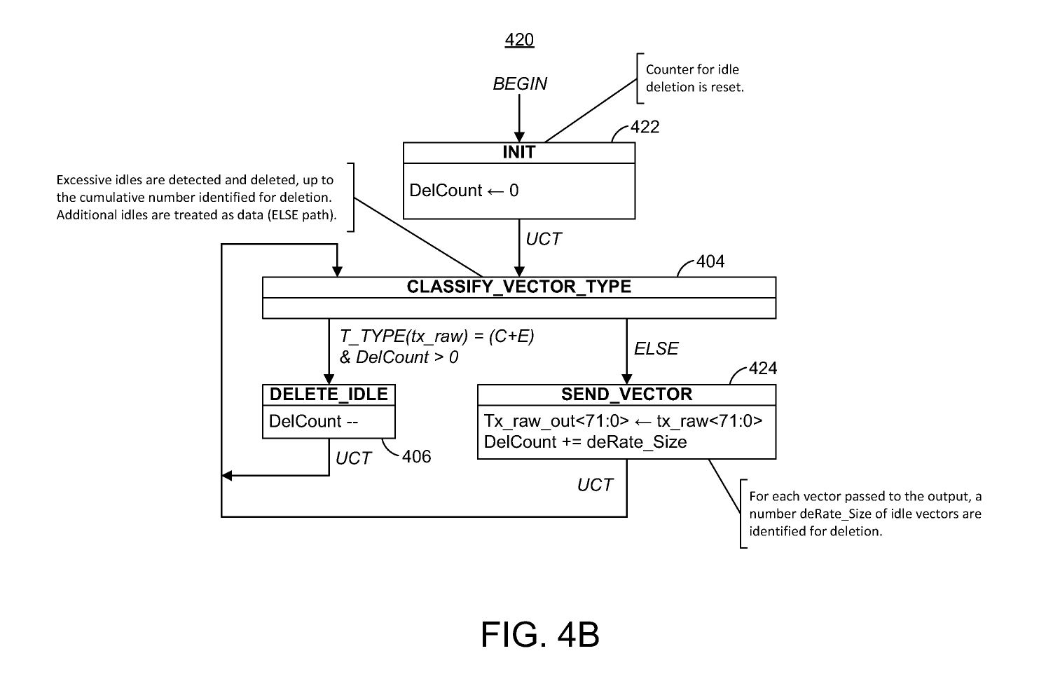

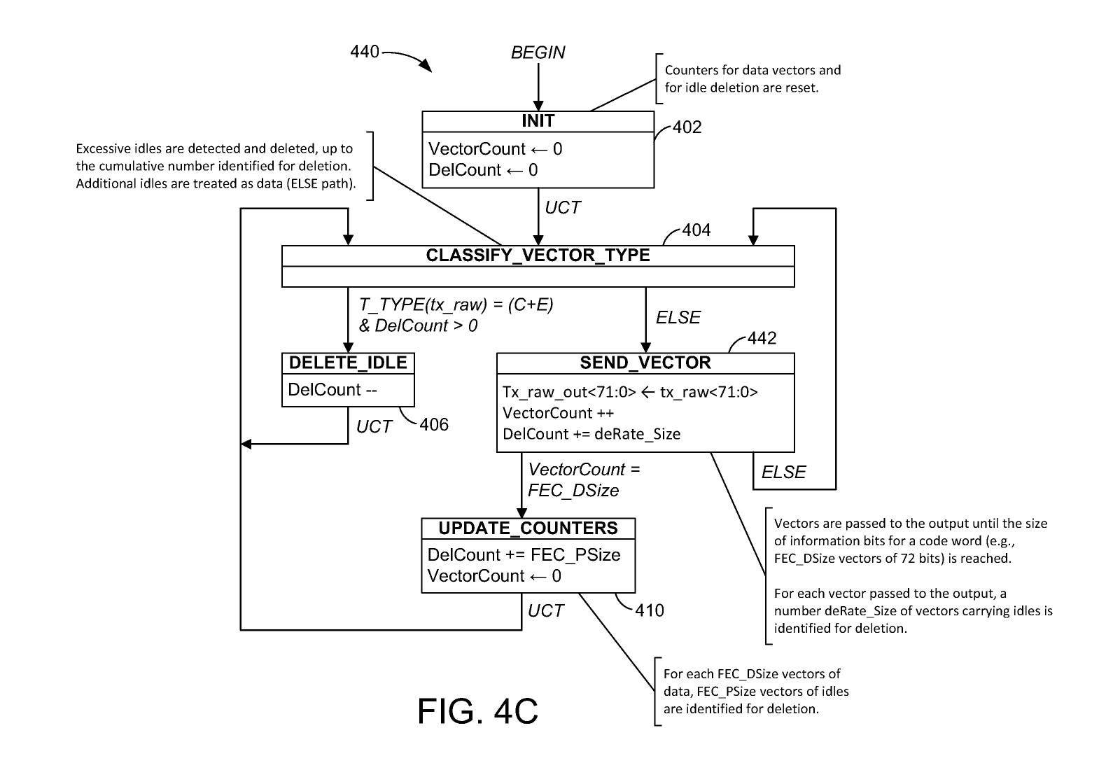

FIG. 4A is a flowchart with pseudo-code 400 illustrating functionality of a state machine that performs FEC idle character deletion for downstream transmission, in accordance with the EPON standard. The state machine of FIG. 4A may be implemented in the PCS 218 of a CLT 162 (FIG. 2A). In an initialization (“Init”) state 402, counters for vectors to be transmitted (“VectorCount”) and to be deleted (“DelCount”) are reset. An unconditional transition then occurs to a “classify vector type” state 404. In the “classify vector type” state 404, the state machine determines whether or not a vector in the transmit bitstream is an idle vector. If T_Type(tx_raw) equals C or E, the vector is an idle vector; otherwise it is not. If the vector is not an idle vector, or if the vector is an idle vector but DelCount is zero, the vector is sent on as output in the “send vector” state 408. The “send vector” state 408 outputs vectors until the number of vectors equals the amount of information for a FEC code word (i.e., until VectorCount=FEC_DSize). At that point, the counters are updated in the “update counters state” 410: DelCount is increased by FEC_PSize and VectorCount is set equal to zero. An unconditional transition then occurs to the “classify vector type” state 404.

If it is determined in the “classify vector type” state 404 that a vector is an idle vector, and if DelCount is greater than zero, then the idle vector is deleted in the “delete idle” state 406 and DelCount is decremented by one. An unconditional transition then occurs to the “classify vector type” state 404. In this manner, idle vectors up to the number identified for deletion in the “update counters” state 410 (i.e., up to FEC_PSize) are deleted. The state machine of FIG. 4A thereby deletes idle characters that were inserted in a bitstream (e.g., the bitstream 260, FIG. 2B) to reserve space for FEC parity bits. The FEC parity bits replace the deleted idle characters.

FIG. 4B is a flowchart with pseudo-code 420 illustrating functionality of a state machine that performs de-rating idle character deletion for downstream transmission, in accordance with some embodiments. The state machine of FIG. 4B is implemented, for example, in the PCS 218 of a CLT 162 (FIG. 2A). In an initialization (“Init”) state 422, DelCount is reset. An unconditional transition then occurs to a “classify vector type” state 404, which operates as described with respect to FIG. 4A. If a vector is not an idle vector, or if the vector is an idle vector but DelCount is zero, the vector is sent on in the “send vector” state 424. For each vector that is sent on as output, DelCount is incremented by deRate_Size, as defined in equation (5). Thus, for each vector that is sent on as output, a number of idle vectors equal to deRate_Size are identified for deletion. Any idle characters beyond those added for de-rating are treated as data and sent on for further processing.

If it is determined in the “classify vector type” state 404 that a vector is an idle vector, and if DelCount is greater than zero, then the idle vector is deleted in the “delete idle” state 406 and DelCount is decremented by one. An unconditional transition then occurs to the “classify vector type” state 404. In this manner, idle vectors up to the number identified for deletion in the “send vector” state 424 are deleted. The state machine of FIG. 4B thereby deletes idle characters that were inserted in a transmit bitstream (e.g., the bitstream 260, FIG. 2B) for de-rating.

FIG. 4C is a flowchart with pseudo-code 440 illustrating functionality of a state machine that combines the functionality of the state machines of FIGS. 4A and 4B for downstream transmission in accordance with some embodiments. Each time a vector is sent, the “send vector” state 442 increments VectorCount by one, as in the “send vector” state 408 (FIG. 4A), and increments DelCount by deRate_Size, as in the “send vector” state 424 (FIG. 4B). The state machine of FIG. 4C, which may be implemented in the PCS 218, thus deletes idle characters added to the transmit bitstream (e.g., the bitstream 260, FIG. 2B) for de-rating and to reserve space for FEC parity bits.

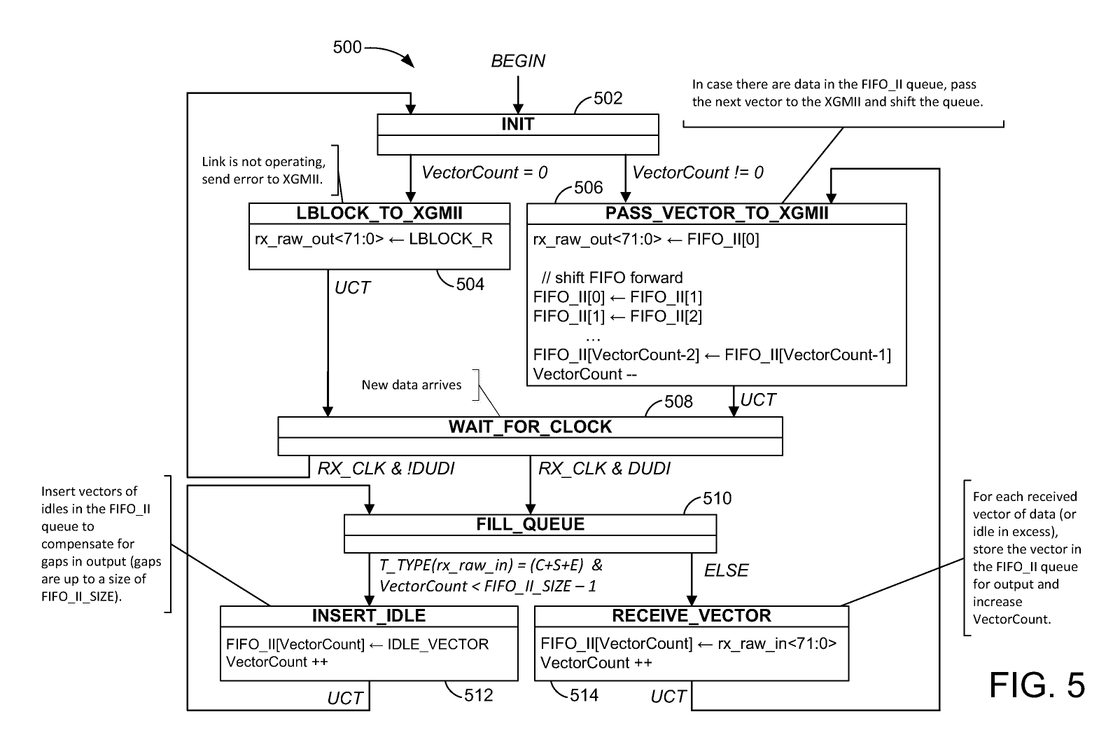

FIG. 5 is a flowchart with pseudo-code 500 illustrating functionality of a state machine for idle character insertion performed as part of downstream reception in accordance with some embodiments. The state machine of FIG. 5, which is implemented in the PCS 246 of a CNU 140 (FIG. 2A), inserts idle characters into the receive bitstream that the PCS 246 provides to the RS 240 through the XGMII 242. The states 502, 504, 506, 508, 510, 512, and 514 of FIG. 5 operate in accordance with the EPON standard, except that the value of FIFO_II_SIZE, which indicates the size of a queue (“the FIFO_II queue”) in the PCS 246, is resized to accommodate the largest possible gap resulting from the combination of FEC and de-rating, as determined based on the maximum frame size at the lowest coax rate and largest parity size. FIFO_II_SIZE thus may be a variable instead of the constant value defined in the EPON standard. The FIFO_II queue queues vectors for transmission across the XGMII 242 from the PCS 246 to the RS 240.

In the pseudo-code 500, an “LBlock to XGMII” state 504 sends an error message to the XGMII 242 indicating that the corresponding link is not operating, based on a determination that VectorCount equals zero. A “pass vector to XGMII” state 506 is reached when VectorCount is not zero, in which case data are in the FIFO_II queue. In the “pass vector to XGMII” state 506, a top vector in the FIFO_II queue is provided to the XGMII 242 and the FIFO_II queue is shifted accordingly. If it is determined in a “fill queue” state 510 that an incoming vector is a data vector (or an excess idle vector), the incoming vector is stored in the FIFO_II queue in a “receive vector” state 514, for subsequent transmission across the XGMII 242. Otherwise, assuming the FIFO_II queue is not full, an idle vector is added to the FIFO_II queue in an “insert idle” state 512, to compensate for gaps in output.

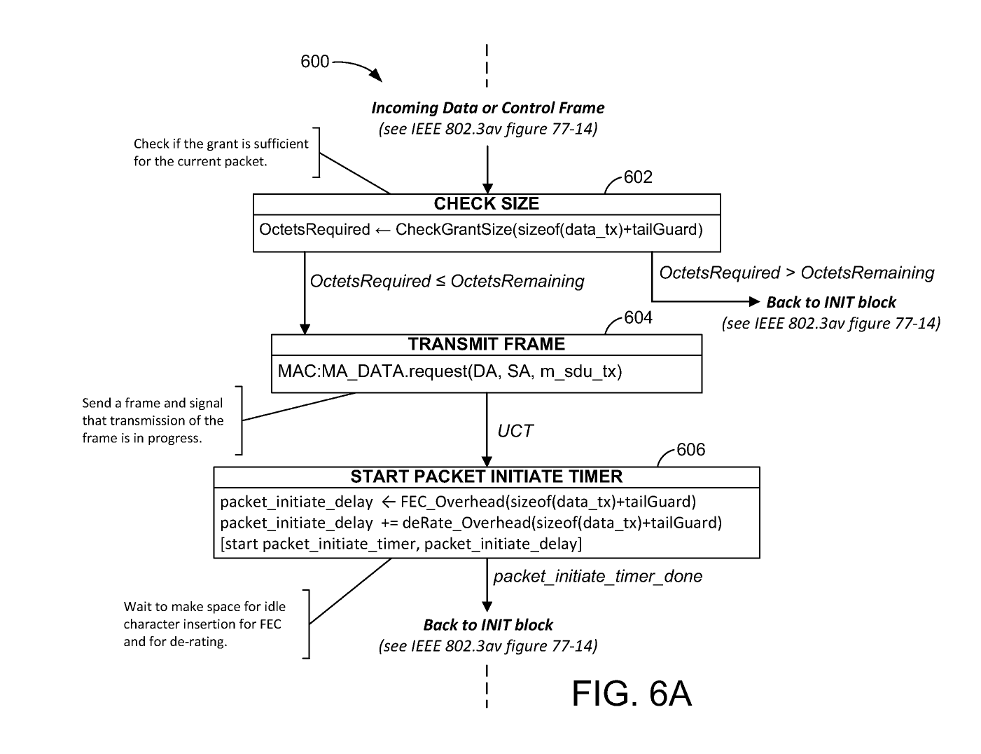

FIG. 6A is a flowchart with pseudo-code 600 illustrating functionality of a state machine for performing idle character insertion for de-rating as part of upstream transmission in accordance with some embodiments. The state machine of FIG. 6A is implemented, for example, in the MAC entity 238 or RS 240 of a CNU 140 and performs idle character insertion in the same manner as the idle character insertion of FIG. 3A, by calculating the packet initiation delay (“packet_initiate_delay”) based in part on the deRate_Overhead function of equation (4), as described with regard to FIG. 3A.

The state machine of FIG. 6A first determines, in a “check size” state 602, whether a grant of upstream transmission bandwidth (e.g., as specified by a GATE message) that the CNU 140 has received is sufficient for transmitting a current packet. A CheckGrantSize function is used to calculate the future time at which transmission of the current frame, including FEC parity overhead, will be complete. This value determines the number of octets required for the transmission. If the number of octets required (“OctetsRequired”) is less than or equal to the number of octets than can be transmitted between the current time and the end of the grant (“OctetsRemaining”), then the current packet may be transmitted and the state machine proceeds to the “transmit frame” state 604. After the frame has been sent, an unconditional transition occurs to a “start packet initiate timer” state 606, which operates in the same manner as the “start packet initiate timer” state 304 (FIG. 3A). The packet initiation timer makes space in the transmit bitstream for idle character insertion that is performed for de-rating, in accordance with the deRate_Overhead function of equation (4), and to reserve space for FEC parity bits that will be inserted in the coax PHY 244 (e.g., in the FEC codec 248, FIG. 2A).

FIG. 6B is a flowchart with pseudo-code 620 illustrating functionality of another state machine for performing de-rating idle insertion for upstream transmission in accordance with some embodiments. The state machine of FIG. 6B is implemented, for example, in the MAC entity 238 or RS 240 of a CNU 140. The pseudo-code 620 for the state machine of FIG. 6B corresponds to the pseudo-code 600 (FIG. 6A), except that the “start packet initiate timer” state 606 is replaced with a “start packet initiate timer” state 622. The “start packet initiate timer” state 622 performs idle insertion in the same manner as the idle insertion of FIG. 3B, by multiplying the packet initiation delay by the scaling factor Rₓ/R_{c}. The packet initiation timer makes space in the transmit bitstream for idle character insertion for de-rating and to reserve space for FEC parity bits.

In systems implemented in accordance with the examples of FIGS. 6A and 6B, the variable fecOffset (e.g., as defined in the EPON standard) counts at the rate R_{c} instead of Rₓ.

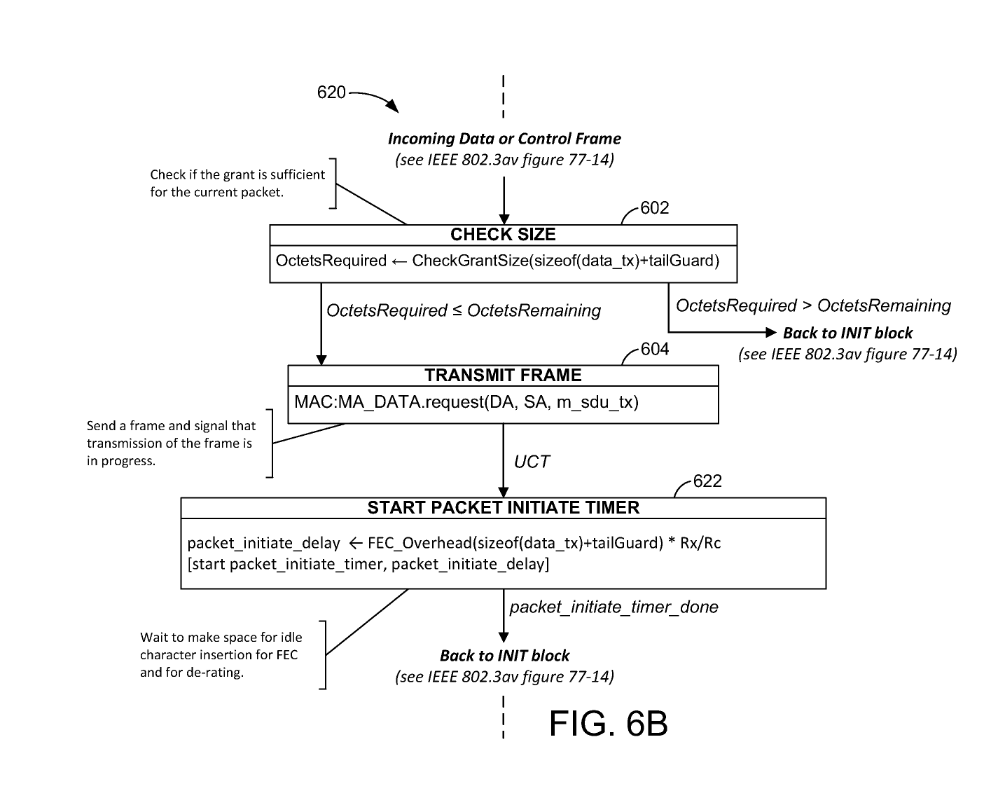

FIG. 7 is a flowchart with pseudo-code illustrating functionality of a state machine that deletes idle characters for upstream transmissions in accordance with some embodiments. The deleted idle characters include idle characters for FEC and for de-rating. The state machine of FIG. 7 is implemented, for example, in the PCS 246 of a CNU 140 (FIG. 2A).

In an initialization (“Init”) state 702, VectorCount and DelCount are reset, as is a counter (“IdleCount”) of idle vectors that are transmitted, as opposed to being deleted. A “next vector ready” state 704 determines whether IdleCount exceeds a delay bound (“DelayBound”). If so, a “reset alignment” state 706 performs an alignment reset by setting counter values as shown. Next, in a “classify vector type” state 708, it is determined whether or not a vector in the transmit bitstream is an idle vector. If the vector is an idle vector and DelCount is greater than zero, then the idle vector is deleted in the “delete idle” state 710, DelCount is decremented by one, and an unconditional transition occurs to the “next vector ready” state 704. The “delete idle” state 710 is analogous to the “delete idle” state 406 (FIGS. 4A-4C). If the vector is not an idle vector, IdleCount is reset to zero in a “send data” state 712. If the vector is an idle vector but DelCount equals zero (“else”), IdleCount is incremented by one in the “send idle” state 714. DelayBound limits the number of idles that may be transmitted in accordance with the “send idle” state 714.

The “send data” state 712 and “send idle” state 714 are followed by unconditional transitions to a “send vector” state 716, which outputs vectors until the number of vectors equals the amount of information for a FEC code word (i.e., until VectorCount=FEC_DSize). Each time a vector is sent, the “send vector” state 716 increments VectorCount by one and increments DelCount by deRate_Size. Once VectorCount=FEC_DSize, counters are updated in the “update counters state” 718: DelCount is increased by FEC_PSize and VectorCount is set equal to zero. An unconditional transition then occurs to the “next vector ready” state 704. The states 716 and 718 are analogous to the states 442 and 410 (FIG. 4C), respectively.

Accordingly, the idle character deletion of FIG. 7 is performed in an analogous manner to the idle character deletion of FIG. 4C, with idle characters that were added to the transmit bitstream (e.g., the bitstream 260, FIG. 2B) for de-rating and to reserve space for FEC parity bits being deleted.

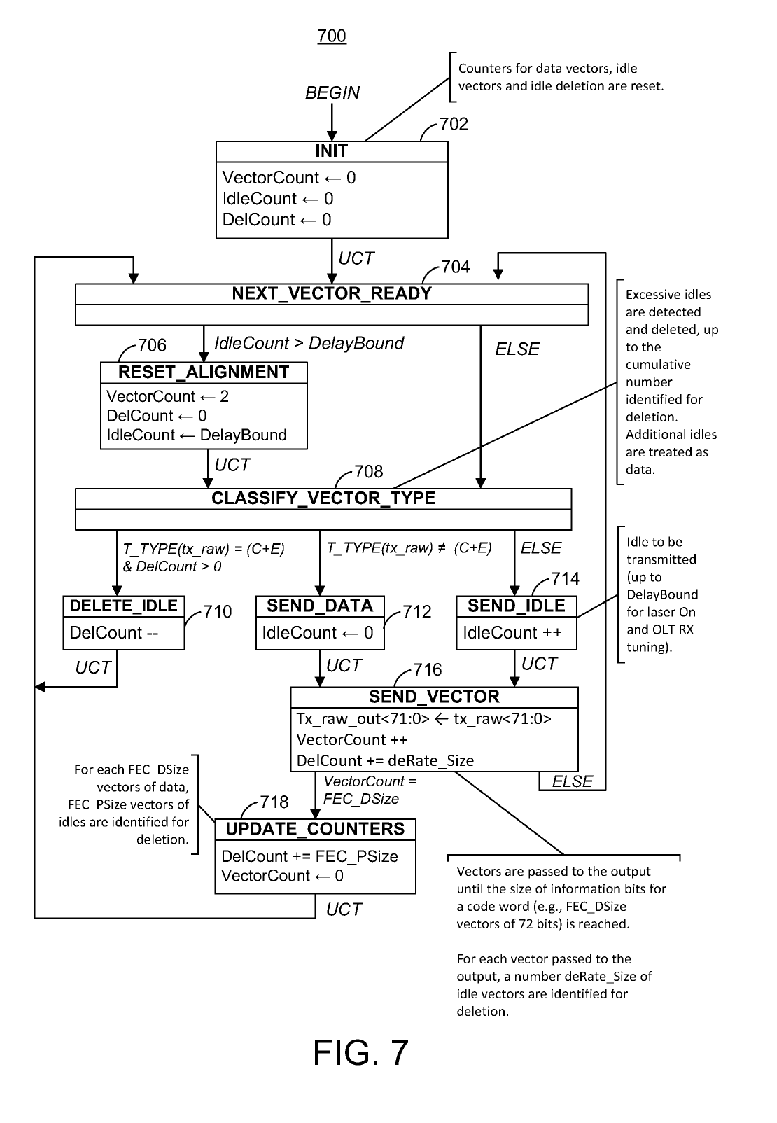

FIG. 8 is a flowchart with pseudo-code 800 illustrating functionality of a state machine for idle character insertion performed as part of upstream reception in accordance with some embodiments. The state machine of FIG. 8, which is implemented for example in the PCS 218 of a CLT 162 (FIG. 2A), inserts idle characters into the receive bitstream that the PCS 218 provides to the RS 212 through the XGMII 214. The states 802, 804, 806, 808, 810, 812, and 814 operate in accordance with the EPON standard, except that the value of FIFO_II_SIZE, which indicates the size of the FIFO_II queue in the PCS 218, is resized to accommodate the largest possible gap resulting from the combination of FEC and de-rating, as determined based on the maximum frame size at the lowest coax rate and largest parity size. FIFO_II_SIZE thus may be a variable instead of the constant value defined in the EPON standard. The FIFO_II queue queues vectors for transmission across the XGMII 214 from the PCS 218 to the RS 212.

In the pseudo-code 800, an “LBlock to XGMII” state 804 sends an error message to the XGMII 214 indicating that the corresponding link is not operating, based on a determination that VectorCount equals zero. A “pass vector to XGMII” state 806 is reached when VectorCount is not zero, in which case data are in the FIFO_II queue. In the “pass vector to XGMII” state 806, a top vector in the FIFO_II queue is provided to the XGMII 214 and the FIFO_II queue is shifted accordingly. If it is determined in a “fill queue” state 810 that an incoming vector is a data vector (or an excess idle vector), the incoming vector is stored in the FIFO_II queue in a “receive vector” state 814, for subsequent transmission across the XGMII 214. Otherwise, assuming the FIFO_II queue is not full, an idle vector is added to the FIFO_II queue in an “insert idle” state 812, to compensate for gaps in output. The pseudo-code 800 thus functions analogously to the pseudo-code 500 (FIG. 5).

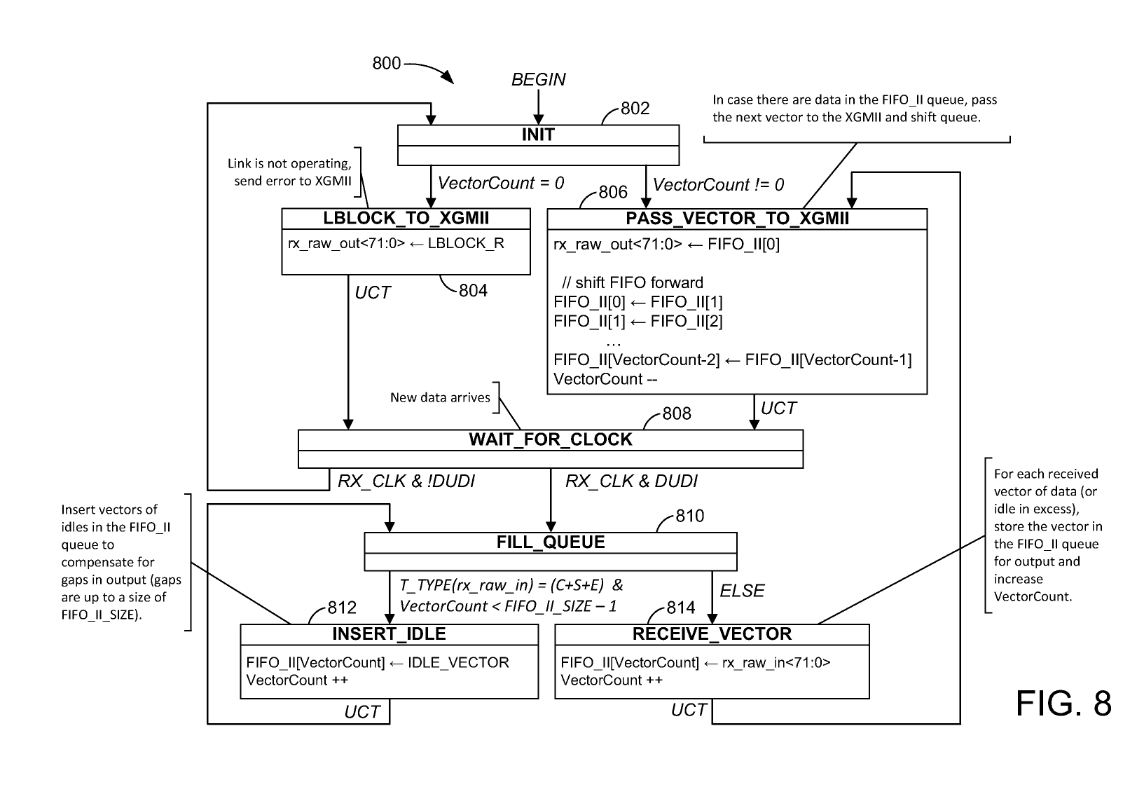

FIG. 9 is a flowchart showing a communications method 900 in accordance with some embodiments. The method 900 is performed (902) in a communication device that includes one or more MAC entities, a coax PHY, and a media-independent interface (e.g., XGMII) coupling the one or more MAC entities with the coax PHY. For example, the method 900 is performed in a CLT 162 or CNU 140 (FIG. 2A).

In the method 900, a bitstream (e.g., bitstream 260, FIG. 2B) is generated (904) that includes data frames and also includes characters (e.g., idle characters) corresponding to time windows in which the coax PHY does not transmit signals. In some embodiments, the one or more MAC entities insert the characters into the bitstream. In some embodiments, the communication device also includes an RS (e.g., RS 212 or RS 240, FIG. 2A), which inserts the characters into the bitstream.

If the communication device is a CLT 162, the time windows in which the coax PHY does not transmit signals include upstream time windows (e.g., upstream time windows 276 and 282, FIG. 2C). If the communication device is a CNU 140, the time windows in which the coax PHY does not transmit signals include downstream time windows (e.g., downstream time windows 272 and 278, FIG. 2C). In either case, the time windows in which the coax PHY does not transmit signals may also include guard intervals (e.g., guard intervals 274 and 280, FIG. 2C).

In some embodiments, generating the bitstream includes inserting (906) a number of idle characters into the bitstream to accommodate a difference in rate between the media-independent interface and the coax PHY. The coax PHY may have a lower rate than the media-independent interface. In some embodiments, generating the bitstream includes inserting (908) idle characters into the bitstream to accommodate inter-packet gaps, FEC encoding, and an absence of traffic. The idle characters are inserted, for example, by the one or more MAC entities and/or by the RS.

In some embodiments, inserting (906) a number of idle characters into the bitstream to accommodate the difference in rate includes increasing a packet initiation delay (e.g., the “packet_initiate_delay” value for the “packet initiate timer” in state 304, FIG. 3A; state 312, FIG. 3B; state 606, FIG. 6A; or state 622, FIG. 6B). For example, a value (e.g., deRate_Overhead, equation (4)) that accommodates the difference in rate is added to the packet initiation delay (e.g., in the state 304, FIG. 3A, or in the state 606, FIG. 6A). In another example, the packet initiation delay is multiplied (e.g., in the state 312, FIG. 3B, or in the state 622, FIG. 6B) by a ratio of the rate of the media-independent interface to the rate of the coax PHY (e.g., by Rₓ/R_{c}).

The bitstream is provided (910) to the coax PHY through the media-independent interface.

When the coax PHY is in a transmit mode (912-TX), signals corresponding to the data frames are transmitted (914) from the coax PHY. In some embodiments, in the course of prepare the signals for transmission, a number of idle characters are removed (916) from the bitstream (e.g., as shown in FIGS. 4B, 4C, and 7). The number of removed idle characters is equal to the number inserted to accommodate the difference in rate between the media-independent interface and the coax PHY. An additional number of idle characters equal to a number inserted for one or more other purposes (e.g., for FEC) may also be deleted (e.g., as shown in FIGS. 4A, 4C, and 7).

When the coax PHY is in a receive mode (912-RX), the bitstream contains (918) the characters corresponding to the time windows: the coax PHY enters the receive mode when the bitstream contains the characters corresponding to the time windows. In some embodiments, the coax PHY enters the receive mode in response to the presence of the characters in the bitstream. In some embodiments, the coax PHY enters the receive mode in response to a control signal provided to the PHY (e.g., by a MAC entity) along with the characters.

While the method 900 includes a number of operations that appear to occur in a specific order, it should be apparent that the method 900 can include more or fewer operations, which can be executed serially or in parallel. Performance of two or more operations may overlap. Two or more operations may be combined into a single operation.

In some embodiments, data link layer and/or reconciliation sublayer functionality as described herein is implemented in software.

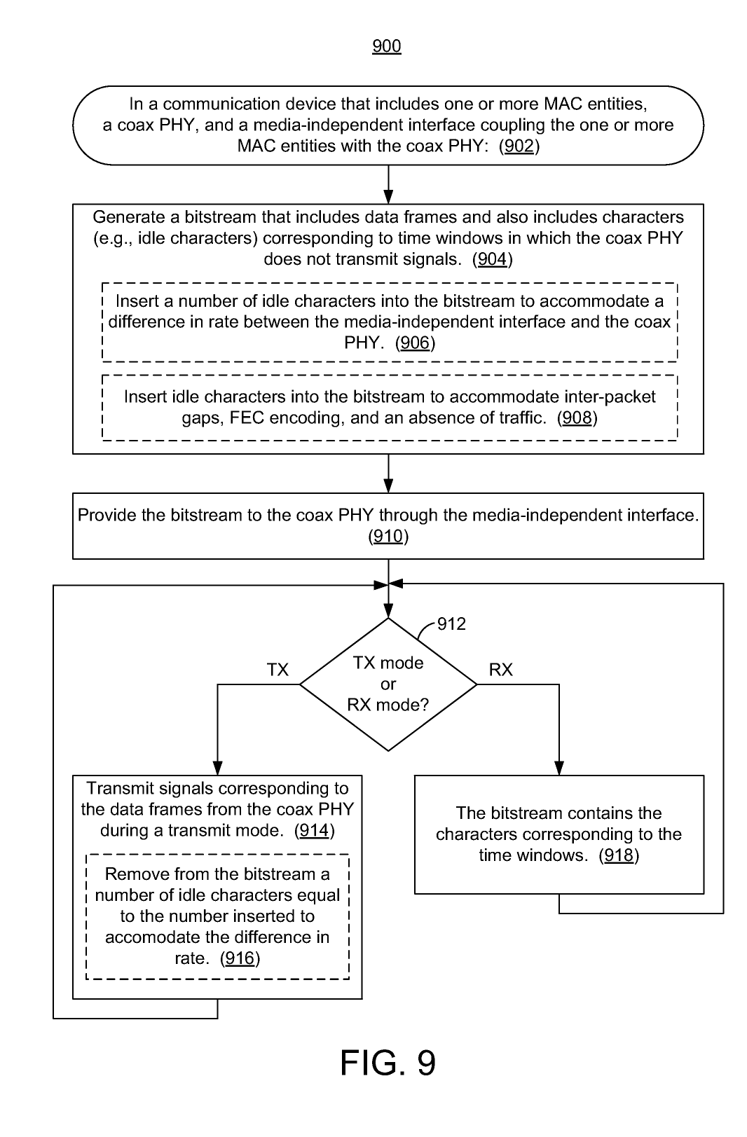

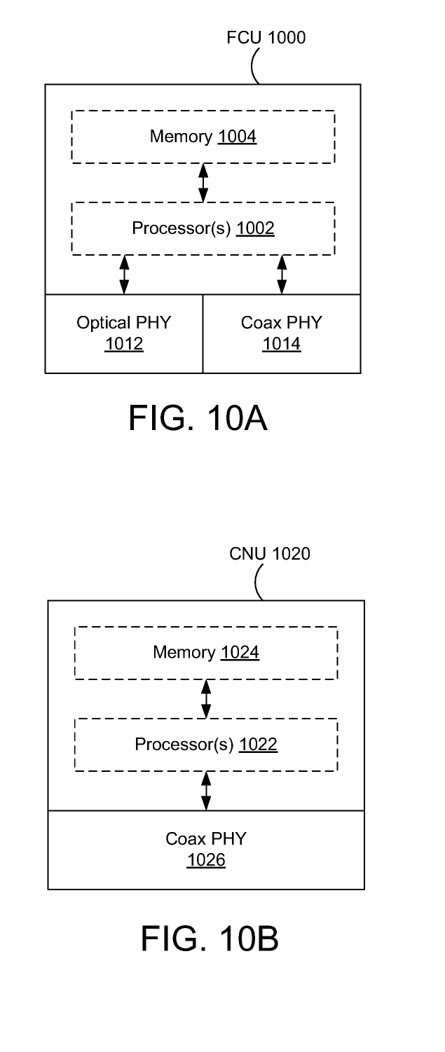

For example, FIG. 10A is a block diagram of an FCU 1000 in a network such as the network 105 (FIG. 1B) in accordance with some embodiments. The FCU 1000 is an example of an FCU 130-1 or 130-2 (FIG. 1B) and may include a CLT 162 (FIGS. 1A-1B and 2A). In the FCU 1000, an optical PHY 1012 and coax PHY 1014 (e.g., coax PHY 216, FIG. 2A) are coupled to one or more processors 1002, which are coupled to memory 1004. In some embodiments, the memory 1004 includes a non-transitory computer-readable medium (e.g., one or more nonvolatile memory elements, such as EPROM, EEPROM, Flash memory, a hard disk drive, and so on) that stores instructions for execution by the one or more processors 1002. The instructions include instructions that, when executed by the processor(s) 1002, cause the FCU 1000 to implement the functionality of the MAC clients 204, OAM sublayers 206, MPCP 208, MAC entities 210, and/or RS 212 (FIG. 2A). For example, the instructions include instructions that, when executed by the processor(s) 1002, cause the FCU 1000 (e.g., the CLT 162 in the FCU 1000) to implement the functionality of the state machines of FIGS. 3A, 3B, 4A, 4B, 4C, and/or 8. The instructions may include instructions that, when executed by the processor(s) 1002, cause the FCU 1000 (e.g., the CLT 162 in the FCU 1000) to perform all or a portion of the method 900 (FIG. 9).

While the memory 1004 is shown as being separate from the processor(s) 1002, all or a portion of the memory 1004 may be embedded in the processor(s) 1002. In some embodiments, the processor(s) 1002 and/or memory 1004 are implemented in the same integrated circuit as the optical PHY 1012 and/or coax PHY 1014. For example, the coax PHY 1014 may be integrated with the processor(s) 1002 in a single chip, while the memory 1004 and optical PHY 1012 are implemented in separate chips. In another example, the elements 1012, 1014, 1004, and 1002 are all integrated in a single chip.

FIG. 10B is a block diagram of a CNU 1020 in accordance with some embodiments. The CNU 1020 is an example of a CNU 140 (FIGS. 1A-1B and 2A). In the CNU 1020, the coax PHY 1026 (e.g., coax PHY 244, FIG. 2A) is coupled to one or more processors 1022, which are coupled to memory 1024. In some embodiments, the memory 1024 includes a non-transitory computer-readable medium (e.g., one or more nonvolatile memory elements, such as EPROM, EEPROM, Flash memory, a hard disk drive, and so on) that stores instructions for execution by the one or more processors 1022. The instructions include instructions that, when executed by the processor(s) 1022, cause the CNU 1020 to implement the functionality of the MAC client 232, OAM sublayer 234, MPCP 236, MAC entity 238, and/or RS 240. For example, the instructions include instructions that, when executed by the processor(s) 1022, cause the CNU 1020 to implement the functionality of the state machines of FIG. 5, 6A, 6B, and/or 7. The instructions may include instructions that, when executed by the processor(s) 1022, cause the CNU 1020 to perform all or a portion of the method 900 (FIG. 9).

While the memory 1024 is shown as being separate from the processor(s) 1022, all or a portion of the memory 1024 may be embedded in the processor(s) 1022. In some embodiments, the processor(s) 1022 and/or memory 1024 are implemented in the same integrated circuit as the coax PHY 1026. For example, the coax PHY 1026 may be integrated with the processor(s) 1022 in a single chip, which may or may not also include the memory 1024.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method, comprising:
in a communication device comprising one or more media access control (MAC) entities, a coax physical layer (PHY), and a media-independent interface coupling the one or more MAC entities with the coax PHY:
generating a bitstream comprising data frames and characters corresponding to time windows in which the coax PHY does not transmit signals;
providing the bitstream to the coax PHY through the media-independent interface;
transmitting signals corresponding to the data frames from the coax PHY during a transmit mode; and
entering a receive mode in the coax PHY when the bitstream contains the characters corresponding to the time windows.

2. The method of claim 1, wherein the characters comprise idle characters.

3. The method of claim 1, wherein the coax PHY enters the receive mode in response to the characters.

4. The method of claim 1, further comprising providing a control signal to the coax PHY to instruct the coax PHY to enter the receive mode.

5. The method of claim 1, wherein generating the bitstream comprises inserting the characters into the bitstream in the one or more MAC entities.

6. The method of claim 1, wherein:
the communication device further comprises a reconciliation sublayer (RS) coupled between the one or more MAC entities and the media-independent interface; and
generating the bitstream comprises inserting the characters into the bitstream in the RS.

7. The method of claim 1, wherein:
generating the bitstream comprises inserting a number of idle characters into the bitstream to accommodate a difference in rate between the media-independent interface and the coax PHY, the coax PHY having a lower rate than the media-independent interface; and
the method further comprises, in the coax PHY, removing from the bitstream a number of idle characters equal to the number of the idle characters inserted into the bitstream to accommodate the difference in rate between the media-independent interface and the coax PHY.

8. The method of claim 7, wherein inserting the number of idle characters into the bitstream to accommodate the difference in rate comprises increasing a packet initiation delay.

9. The method of claim 8, wherein increasing the packet initiation delay comprises adding to the packet initiation delay a value that accommodates the difference in rate.

10. The method of claim 8, wherein increasing the packet initiation delay comprises multiplying the packet initiation delay by a ratio of the rate of the media-independent interface to the rate of the coax PHY.

11. The method of claim 7, wherein generating the bitstream further comprises inserting idle characters into the bitstream to accommodate inter-packet gaps, forward-error-correction (FEC) encoding, and an absence of traffic.

12. The method of claim 1, wherein:
the communication device comprises a coax line terminal; and
the time windows in which the coax PHY does not transmit signals comprise upstream time windows.

13. The method of claim 1, wherein:
the communication device comprises a coax network unit; and
the time windows in which the coax PHY does not transmit signals comprise downstream time windows.

14. A communication device, comprising:
one or more MAC entities to provide data frames;
a coax PHY to transmit signals corresponding to the data frames during a transmit mode and to cease transmission during a receive mode; and
a media-independent interface to provide to the coax PHY a bitstream comprising the data frames and characters corresponding to time windows in which the coax PHY does not transmit signals;
wherein the coax PHY is to enter the receive mode when the bitstream contains the characters corresponding to the time windows.

15. The communication device of claim 14, wherein the coax PHY is to enter the receive mode in response to the characters.

16. The communication device of claim 14, wherein the coax PHY is to enter the receive mode in response to a control signal.

17. The communication device of claim 14, wherein the one or more MAC entities are to insert the characters into the bitstream.

18. The communication device of claim 14, further comprising a reconciliation sublayer, coupled between the one or more MAC entities and the media-independent interface, to insert the characters into the bitstream.

19. The communication device of claim 14, wherein:
the coax PHY has a lower rate than the media-independent interface;
the bitstream comprises a number of idle characters that accommodate a difference in rate between the media-independent interface and the coax PHY; and
the coax PHY is to remove from the bitstream a number of idle characters equal to the number of idle characters that accommodates the difference in rate between the media-independent interface and the coax PHY.

20. The communication device of claim 19, further comprising a timer to delay packet initiation to allow insertion into the bitstream of the number of idle characters that accommodate the difference in rate between the media-independent interface and the coax PHY.

21. The communication device of claim 14, wherein the media-independent interface comprises a 10 Gigabit Media-Independent Interface (XGMII).

22. A non-transitory computer-readable storage medium storing one or more programs configured to be executed by one or more processors in a communication device, the one or more programs comprising:
instructions to generate a bitstream comprising data frames and characters corresponding to time windows in which a coax PHY in the communication device does not transmit signals; and
instructions to provide the bitstream to the coax PHY through a media-independent interface in the communication device;
wherein the coax PHY is to transmit signals corresponding to the data frames during a transmit mode and to enter a receive mode when the bitstream contains the characters corresponding to the time windows.

23. The computer-readable storage medium of claim 22, wherein the one or more programs further comprise instructions to provide a control signal to the coax PHY to instruct the coax PHY to enter the receive mode.

24. The computer-readable storage medium of claim 22, wherein the instructions to generate the bitstream comprise instructions to insert idle characters into the bitstream to accommodate a difference in rate between the media-independent interface and the coax PHY, the coax PHY having a lower rate than the media-independent interface.

25. The computer-readable storage medium of claim 24, wherein the instructions to insert idle characters into the bitstream comprise instructions to increase a packet initiation delay.

26. The computer-readable storage medium of claim 25, wherein the instructions to increase the packet initiation delay comprise instructions to add to the packet initiation delay a value that accommodates the difference in rate.

27. The computer-readable storage medium of claim 25, wherein the instructions to increase the packet initiation delay comprise instructions to multiply the packet initiation delay by a ratio of the rate of the media-independent interface to the rate of the coax PHY.

28. The computer-readable storage medium of claim 24, wherein the instructions to generate the bitstream further comprise instructions to insert idle characters into the bitstream to accommodate inter-packet gaps, FEC encoding, and an absence of traffic.

29. A communication device, comprising:
first means for transmitting signals corresponding to data frames during a transmit mode and not during a receive mode; and
second means for providing to the first means a bitstream comprising data frames and characters corresponding to time windows in which the first means does not transmit signals,
wherein the first means is to enter the receive mode when the bitstream contains the characters corresponding to the time windows.

30. The communication device of claim 29, wherein the first means is to enter the receive mode in response to the characters.

31. The communication device of claim 29, wherein the first means is to enter the receive mode in response to a control signal.

32. The communication device of claim 29, further comprising means for inserting the characters into the bitstream.

33. The communication device of claim 29, further comprising means for inserting a number of idle characters into the bitstream to accommodate a difference in rate between the first means and the second means, the first means having a lower rate than the second means;
wherein the first means comprises means for removing from the bitstream a number of idle characters equal to the number of the idle characters inserted into the bitstream to accommodate the difference in rate between the media-independent interface and the coax PHY.
